(19) United States
(12) Patent Application Publication
(10) Pub. No.: US 2004/0077893 A1
(43) Pub. Date: Apr. 22, 2004

(54) Synthesis of bis (trialkylsilyl) amide and composition obtained

(75) Inventor: Gerard Forat, Lyon (FR)

Correspondence Address: BURNS, DOANE, SWECKER & MATHIS, L.L.P., P.O. Box 1404, Alexandria, VA, 22313-1404, US

(73) Assignee: RHODIA CHIMIE, Courbevoie Cedex (FR)

(21) Appl. No.: 10/617,729

(22) Filed: Jul. 14, 2003

Related U.S. Application Data
(63) Continuation of application No. 09/319,967, filed on Sep. 7, 1999, now abandoned.
Application No. 09/319,967 is a 371 of international application No. PCT/FR97/02276, filed on Dec. 11, 1997.

(30) Foreign Application Priority Data
Dec. 12, 1996 (FR) 96/15.279

(51) Int. Cl. C07F 7/04

(52) U.S. Cl. 556/419

(57) ABSTRACT

The invention relates to the synthesis of bis trialkylsilylamide. The synthesis includes subjecting the amide to the action of a trialkylsilyl halide on an amide bearing a Rf group in the presence of a base whose halide, or halohydrate, is insoluble in the presence of a covalent and non-hydrophilic solvent. The invention is applicable to organic synthesis.

### SYNTHESIS OF BIS(TRIALKYLSILYL)AMIDE AND COMPOSITION OBTAINED

The present invention relates to the synthesis of bis(silyl)amide, more particularly to compositions with a high content of N,O-bis(trialkylsilyl)amide. The invention relates more particularly to bis(trialkylsilyl)amides which can be used as silylating agents.

It is known practice to use bis(silyl)amides as silylating agents which do not give rise to inorganic salts; these products are particularly advantageous; reference may be made in particular to the French patent application published under No. 2,574,078 and entitled: “Process for producing persilyl carboxylic acid amides” [sic].

However, it is extremely difficult to obtain these compounds with a degree of purity which is sufficient to make them easy to use. Among the problems encountered in this use, mention may be made of

the presence of impurity, which reduces the stability and harms its storage;

the presence of monosilyl derivative, which makes it difficult to use since the monosilyl derivative also has silylating ability, but with different reactivity.

This presence is all the more of an inconvenience since it is difficult to obtain reproducible contents of mono derivative in the bis d rivative.

The two bis isomers do not have identical reactivity and cannot be separated by physical m ans.

The problem is further complicated by the great similarity of the physical properties of the monosilyl derivatives with respect to the bis-silyl derivatives. This makes the separation, in particular by distillation, very difficult and often incomplete with. laboratory techniques and impracticable on the industrial scale.

Accordingly, one of the aims of the present invention is to provide a process for obtaining N,O-bis(silyl)amides.

Another aim of the present invention is to provide a process of the above type for obtaining N,O-bis(silyl) amides directly with a high degree of purity.

Another aim of the present invention is to provide a process of the above type for obtaining N,O-bis(silyl) amides directly with a degree of purity at least equal to 90%, advantageously to 95%.

Another aim of the present invention is to provide N,O-bis(silyl)amides whose degree of purity is at least equal to 95%, advantageously to 98%.

These aims and others which will become apparent hereinbelow are achieved by means of a process in which the amide is subjected to the action of a trialkylsilyl halide on an amide bearing a group Rf in the presence of a base whos halide, or hydrohalide, is insoluble in the medium and in the presence of a non-polar and non-hydrophilic solv nt.

It is preferable for th solvent to be v ry sparingly basic and its basicity is assessed with reference to the “donor number”.

An organic solvent with a donor number not greater than that of cyclohexane is preferably chosen. It is even preferable for it to be too low to be measured! There is no critical nature attached to the lower limit.

As regards the requirements relating to the basicity of the organic solvent to be used, it will be recalled that the “donor number”, sometimes denoted by the abbreviation “DN”, gives an indication as to the nucleophilic nature of the solvent and reveals its ability to donate a lone pair.

A definition of the “donor number” is found in the book by Christian Reinhardt, [Solvents and Solvent Effects in Organic Chemistry—VCH p. 19 (1988)], which is defined as the negative. (−ΔH) of the enthalpy (Kcal/mol) of the interaction between the solvent and antimony pentachloride, in a dilute dichloromethane solution.

As non-polar solvent, mention should be made of those which have a relative dielectric constant epsilon of not more than 5.

The said solvent is advantageously such that water has a solubility therein of only 1% at most, pref rably 50 ppm.

It is desirable for the said solvent to b such that the reaction mixture fully dissolves the bis(silyl)amide.

The said solvent can be a mixture of various solvents.

It is desirable for the said solvent to be chosen from hydrocarbons, which are advantageously aliphatic and preferably non-cyclic, silanes and fluorohydrocarbons, and mixtures thereof.

The said solvent is chosen from those whose (starting) boiling point is, at atmospheric pressure, not more than about 100° C. (advantageously two significant figures).

According to one particularly advantageous embodiment of the present invention, the said solvent is chosen from those whose (starting) freezing point is, at atmospheric pressure, not more than 0° C., advantageously not more than −10° C.

As regards the said base, it is advantageously organic. It is desirable for the said base not to be silylable.

According to an advantageous variant of the present invention, the said base is an organic base which contains not more than about 10 (preferably two significant figures) carbon atoms per basic function.

The said base is generally a pnictine.

The term pnictine means hydrocarbon-based trivalent derivatives of the elements from column VB, of a period at least equal to the second and in general lower than the sixth (the elements nitrogen, phosphorus, arsenic and antimony are more particularly intended) of the Periodic Table of the Elements (supplement to the Bulletin de la Société Chimique de France, January 1966, No. 1). More specifically, they are hydrocarbon-based derivatives of the elements from column V. They are derived from hydrogen pnictides by total or partial substitution of hydrogen with hydrocarbon-based residues which can be alkyl [in the present description ALK-yl is taken in its etymological sense as the hydrocarbon residue of an ALKAN-ol after disregarding the alcohol (or -ol) function] or aryl, connected via a single bond to the atom from column VB.

Thus, in the case of nitrogen, the substitution of hydrogen nitride (ammonia) gives amines, in the case of phosphorus, the substitution of hydrogen phosphide gives phosphines, in the case of arsenic, the substitution of hydrogen arsenide gives arsines and in the case of antimony, the substitution of hydrogen antimonide (or stibide) gives stibines.

Thus, the organic bases consisting of hydrocarbon-based derivatives of the elements from column V are advantageously derived from hydrogen pnictides by total or partial substitution of the hydrogen with monovalent hydrocarbon-based residues, advantageously with alkyls [in the present description, ALK-yl is taken in its etymological sense as the hydrocarbon r sidue of an ALKAN-ol after disregarding the alcohol (or -ol) function]; these alkyl compounds are, by analogy with the term pnictide, denoted in the present description by the term pnictines.

It is desirable for the said base to be an organic base whose conjugate acid is not silylable.

It is preferable for the said base to be an organic base which contains not more than about 10 (preferably two significant figures), preferably not more than 8, atoms (excluding hydrogen) per basic function.

The said base advantageously contains an amine function.

It is preferable for the amine to be at least partially soluble in the said amide, advantageously totally soluble.

The amides mainly targeted are those which have the following formula:

Rf—CO—NH₍₂₋ₓ₎—[Si(R₁)(R₂)(R₃)]ₓ

with x representing 0 or 1;

with R₁, R₂ and R₃ being chosen from alkyl groups containing from 1 to 10 carbon atoms, optionally connected to one of the other groups R₁, R₂ and R₃;

with Rf (perfluoroalkyl) meaning radicals of formula:

—(CX₂)ₚ-EWG

where the identical or different groups X represent a fluorine or a radical of formula CₙF₂ₙ₊₁where n is an integer not gr ater than 5, preferably not gr ater than 2; where p represents an integer not greater than 2; where EWG represents an electron-withdrawing group whose functions, if any, are inert under the reaction conditions, advantageously fluorine or a perfluoro residue of formula CₙF₂ₙ₊₁ where n is an integer not greater than 8, advantageously not greater than 5.

The total number of carbons in Rf is advantageously between 1 and 10, preferably between 1 and 5.

In general, the said amide is an amide chosen from those of pentafluoropropanoic acid and those of trifluoroacetic acid.

According to a particularly advantageous embodiment of the present invention, a mixture of y mol (advantageously y is between x/10 and x/2 mol) of amide and of trialkylamine (from two y to 5 y equivalents) is poured onto a feedstock of alkane(s) (CS to CB) (volume in the region of one and a half times [from 50 to 250% by volume] the amount of the other reagents) and x mol of halosilane.

The addition is carried out while keeping the temperature at the reflux point or close to it. At the end of the addition, this reflux is maintained for 1 hour to one day.

At the end of the reaction, the reaction medium is cooled to room temperature and the white precipitate form d is filtered off while maintaining an in rt and dry atmosphere. The precipitate is washed using a relatively non-polar alkane, advantageously an n-alkane, preferably pentane or hexane.

The non-limiting examples below illustrate the invention.

### EXAMPLE NO. 1

### Synthesis of Bis (Trimethylsilyl) Trifluoroacetamide

A mixture of 0.2 mol (22.6 g) of trifluoroacetamide and 0.6 mol (60.6 g) of triethylamine is added to a feedstock of 120 ml of pentane and 0.8 mol (90.4 g) of Me₃SiCl.

The addition is carried out at a flow rate of 14 ml/h while keeping the temperature at the reflux point. At the end of the addition, this reflux is maintained for 11 hours 30 min.

At the end of the reaction, the reaction medium is cooled to 20° C. and the white precipitate formed is filtered off, while maintaining an inert and dry atmosphere. The precipitate is washed with pentane.

The filtrate is distilled rapidly to remove the reaction solvent (pentane). The residue is then rectified on a 10-theoretical-plate column.

The bis derivative is thus isolated (boiling at 59.6° C.-60.1° C. at 60 mbar) with a DC relative to the acetamide of 100% and a selectivity towards bis(trimethylsilyl)trifluoroacetamide of 89%. The purity of the sample is greater than 99.5%.

### EXAMPLE NO. 2

### Role of the Solvent

Identical to Example 1, except than hexane is used as solvent.

The rectified bis(trimethylsilyl)trifluoroacetamide is obtained with a DC of 100% and a selectivity of 95%.

### EXAMPLE NO. 3

### Use of Other Amines

| | | | | | RY/ | RY/ |
|---|---|---|---|---|---|---|
| Dura- | | | | DC/ | bis | mono |
| tion | | | | acet- | deri- | deri- |
| (hrs) | φ° C. | Solvent | Amine | amide | vative | vative |
| 11.30 | 47 | pentane | Et₃N | 100 | 98 | 2 |
| 16 | 68 | — | HMDZ + Et₃N | 100 | 50 | 50 |
| 3 | 50 | pentane | Bu₃N^{(a)(**)} | 100 | 0 (25) | 0 (75) |
| 14 | 70 | HMDZ | pyridine | 100 | 0 | 100 |
| 3 | 50 | pentane | diiso- | 100 | 0 (25) | 0 (75) |
| | | | propyl - | | | |
| | | | ethyl- | | | |
| | | | amine^{(a)(**)} | | | |
| 3 | 50 | pentane | Oct₃N (a) | 100 | 0 | 0 |
| 3 | 60 | — | HMDZ | 100 | 0 | 100 |

^{*}temperature
^{(a)}At the end of the addition of the amide + tertiary amine mixture, the presence of mono- and bis(trimethylsilyl)trifluoroacetamide is observed, which disappears over time.
^{(**)}At the end of the addition of the amide + tertiary amine mixture, the RY of bis derivative is about 25% and the RY of mono derivative is 75% - result obtained by GC analysis.

1. Process for silylating an acylamide, characterized in that an amide bearing a group Rf (perfluoroalkyl) is subjected to the action of a trialkylsilyl halide in the presence of a base whose halide, or hydrohalide, is insoluble in the medium and in the presence of a non-polar and non-hydrophilic solvent.

2. Process according to claim 1, characterized in that the said solvent has a relative dielectric constant epsilon of not more than 5.

3. Process according to claims 1 and 2, characterized in that the said solvent is such that water has a solubility therein of only 1% at most.

4. Process according to claims 1 to 3, characterized in that the said solvent is such that the reaction mixture fully dissolves the silylamide.

5. Process according to claims 1 to 4, characterized in that the said solvent is a mixture.

6. Process according to claims 1 to 5, characterized in that the said solvent is chosen from hydrocarbons, which are advantageously aliphatic and preferably acyclic, silanes and fluorohydrocarbons.

7. Process according to claims 1 to 6, characterized in that the said solvent is chosen from those whose (starting) boiling point is, at atmospheric pressure, not more than about 100° C. (advantageously two significant figur s).

8. Process according to claims 1 to 7, characterized in that the said solvent is chosen from those whose (starting) freezing point is, at atmospheric pressure, not more than 0° C., advantageously not more than −10° C.

9. Process according to claims 1 to 8, characterized in that the said base is an organic base.

10. Process according to claims 1 to 9, characterized in that the said base is a non-silylable organic base.

11. Process according to claims 1 to 10, characterized in that the said base is an organic base whose conjugate acid is not silylable.

12. Process according to claims 1 to 11, characterized in that the said base is a pnictine.

13. Process according to claims 1 to 12, characterized in that the said base is an organic base which contains not more than about 10 (preferably two significant figures) atoms per basic function.

14. Process according to claims 1 to 13, characterized in that the said base is an organic base which contains not more than about 8 (preferably two significant figures) atoms per basic function.

15. Process according to claims 1 to 14, characterized in that the said base is an amine.

16. Process according to claims 1 to 15, characterized in that the said amide has the following formula:
Rf—CO—NH₍₂₋ₓ₎—[Si(R₁)(R₂)(R₃)]ₓ
with x representing 0 or 1;
with R₁, R₂ and R₃ being chosen from alkyl groups containing from 1 to 10 carbon atoms, optionally connected to one of the other groups R₁, R₂ and R₃;
with Rf (perfluoroalkyl) meaning radicals of formula:
—(CX₂)ₚ—EWG
where the identical or different groups X represent a fluorine or a radical of formula CₙF₂ₙ₊₁where n is an integer not greater than 5, preferably not greater than 2;
where p represents an integer not greater than 2;
where EWG represents an electron-withdrawing group whose functions, if any, are inert under the reaction conditions, advantageously fluorine or a perfluoro residue of formula CₙF₂ₙ₊₁where n is an integer not greater than 8, advantageously not greater than 5;
the total number of carbons in Rf is advantageously between 1 and 10, preferably between 1 and 5.

17. Process according to claims 1 to 16, characterized in that the said amide is an amide chosen from those of pentafluoropropanoic acid and those of trifluoroacetic acid.

18. Composition containing at least 95%, advantageously 98%, of N,O-bis(silyl)amides of pentafluoropropanoic acid or of trifluoroacetic acid.
